(19) United States
(12) Patent Application Publication
(10) Pub. No.: US 2010/0196672 A1
(43) Pub. Date: Aug. 5, 2010

(54) NON-WOVEN MATERIAL

(75) Inventor: Achai Bonneh, Kochav Yair (IL)

Correspondence Address: THE NATH LAW GROUP, 112 South West Street, Alexandria, VA, 22314, US

(73) Assignee: AVGOL INDUSTRIES 1953 LTD., Tel Aviv (IL)

(21) Appl. No.: 12/669,725

(22) PCT Filed: Jul. 20, 2008
(86) PCT No.: PCT/IL08/01006

§ 371 Date: Jan. 19, 2010

Related U.S. Application Data
(60) Provisional application No. 60/929,950, filed on Jul. 19, 2007.

(51) Int. Cl. D04H 3/10; D04H 3/16; D04H 3/14; B32B 3/00; D04H 3/00

(52) U.S. Cl. 428/174; 442/328; 264/103; 28/100

(57) ABSTRACT

A non-woven material is provided, comprising an external non-elastic base layer and an auxiliary layer comprising an elastic material, the base layer and auxiliary layer being mechanically bonded to one another.

### FIELD OF THE INVENTION

This invention relates to a non-woven material.

### BACKGROUND OF THE INVENTION

Non-woven materials or textiles are a type of fabric-like material which is typically manufactured by mechanically, thermally, or chemically binding fibers, either from natural fibers or manmade materials.

One example of a non-woven material is a multi-layer material comprising several layers, each of which may be manufactured using either a spunbond, carded thermo-bond, or meltblown process. In the spunbond process, raw material is extruded into a thin fiber (on the order of several microns), and the extruded fiber is randomly deposited on a conveyor belt. In the meltblown process, fibers are extruded and then blown onto another layer or directly onto a conveyor belt. The layers are then mechanically or thermally bonded, i.e., via heat bonding or hydro-entanglement. In addition, additives, either to the materials themselves or in the form of surfactants, may be provided. It is well known that the parameters used in each step of the manufacture affect properties of the final material.

### SUMMARY OF THE INVENTION

According to one aspect of the present invention, there is provided a non-woven material comprising a non-elastic base layer and an auxiliary layer comprising an elastic material, the base layer and auxiliary layer being mechanically bonded, such as with hydro-bonding and/or needle punching, together. The non-woven material may be pre-stretched.

It will be appreciated that the term “elastic” as used hereafter in the specification and claims refers to a material which exhibits significant elastic properties, i.e., it is a material which is usually selected due to those properties. For example, it exhibits significant stretch and recovery and/or is made from an elastomer material.

The base layer may comprise a layer selected from the group comprising a spunbond layer, a carded thermo-bond layer, and a meltblown layer.

The auxiliary layer may comprise one or more layers, each selected from the group comprising a spunbond layer, a carded thermo-bond layer, and a meltblown layer.

At least one of the auxiliary layers may a thermoplastic elastomer material, such as polypropylene, polyethylene, and polystyrene.

At least one of the auxiliary layers may comprise a material selected from the group comprising thermoplastic elastomeric material, elastomeric block copolymer, amorphous polyolefin plastomer, and thermoplastic elastomeric copolymer.

At least one of the layers may be made of two different materials formed as a bi-component material.

The non-woven material may have a stretching ratio substantially in the range between 10-400% elongation, and it may have a permanent set substantially equal to or below 20%, and more particularly within substantially within the range of 8%-15%.

The base layer may be micro-pleated.

According to another aspect of the present invention, there is provided an article comprising a non-woven material as above.

The article may be a diaper, with the non-woven material constituting at least a portion of a waistband, back-ear material, or elastic back-sheet component thereof. The article may further be a garment.

According to a further aspect of the present invention, there is provided a process for manufacturing a non-woven material, the method including:
(a) providing a non-elastic base layer;
(b) providing at least one auxiliary layer of an elastic material on the base layer; and
(c) mechanically bonding, e.g., using hydro-entanglement, the base and auxiliary layers to form the non-woven material.

The process may further comprise stretching the material in at least one of two perpendicular directions. According to one specific example, the process comprises multiple stretchings of the material in at least one (i.e., in one or both) of the directions; different stretchings, either in the same direction or in different directions, may be performed at different amounts. At least some of the stretchings may be performed while the material is heated, or in the absence of additional heating.

The layers may further be subjected to hydro entanglement and/or needle punching.

The process may further comprise calendaring the material, such as partial calendaring, for example to impart an aesthetic pattern thereto.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIGS. 1A through 1D are schematic cross-sectional views of non-woven materials;

FIG. 2 is a schematic illustration of a setup manufacturing the non-woven material illustrated in FIG. 1C; and

FIG. 3 is a hysteresis curve of one example of a non-woven material illustrated in FIG. 1C.

### DETAILED DESCRIPTION OF EMBODIMENTS

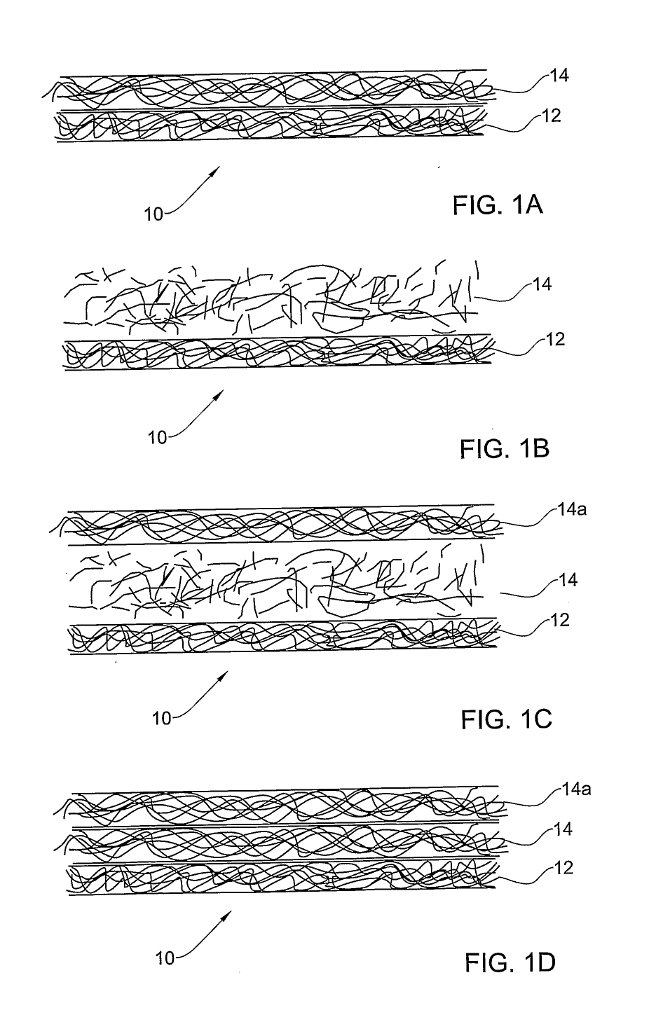

As illustrated in FIGS. 1A through 1C, a non-woven material, which is generally indicated at 10, is provided. The material 10 comprises at least two layers. The material 10 comprises at least one base layer 12 and at least one auxiliary layer 14.

The base layer 12 comprises at least one spunbond (S), meltblown (M), or carded thermo-bond layer (T) of polyolefin (PO) or any other suitable material. It may be a mono-filament material, such as polypropylene (PP) or polyethylene (PE), or a bi-component material, such as a “sheath-and-core” arrangement of PP and PE, or a “side-by-side” arrangement of PP and PE.

The auxiliary layer 14 includes at least one meltblown (M), spunbond (S), or carded thereto-bond (T) layer, which is made of an elastic material, such as a thermoplastic elastomeric material, an elastomeric block copolymer, an amorphous polyolefin plastomer, thermoplastic elastomeric copolymer or mixtures thereof. Additional auxiliary layers 14a may be made of a spunbond, carded thermo-bond, or meltblown material, which may be elastic, but need not be.

In FIG. 1A, an example of a material with a spunbond base layer 12 and a spunbond elastic auxiliary layer 14 is illustrated; this arrangement may be designated as SS. In FIG. 1B, an example of a material with a spunbond base layer 12 and a meltblown elastic auxiliary layer 14 is illustrated; this arrangement may be, designated as SM. In FIG. 1C, an example of a material with a spunbond base layer 12, an auxiliary elastic meltblown layer 14, and a spunbond PO additional auxiliary layer 14a is illustrated; this arrangement may be designated as SMS. In FIG. 1D, an example of a material with a spunbond base layer 12, an auxiliary elastic spunbond layer 14, and a spunbond PO additional auxiliary layer 14a is illustrated; this arrangement may be designated as SSS. It will be appreciated that while materials of the types SS, SM, SMS and SSS are illustrated in FIGS. 1A through 1D, other combinations are possible. Fort example, the material 10 may be formed as SMMS, SSMSS, SMSS, SSMMMSS, TM, STM, ST, STTS, etc.

The base layer 12 may have a basis weight of 3-30 g/m², and a fiber diameter which is in the range of 8-25 microns. Each of the auxiliary layers 14 may have a basis weight of 5-70 g/m² and a fiber diameter which is in the range of 10-35 microns. The material 10 may have a basis weight in the range of 10-140 g/m², depending on its constituent layers. It will be appreciated that the basis weight of the material may fall outside the given range, for example if many layers are included.

The layers are hydro-entangled to form a composite. The composite, either in-line or off-line, is stretched at ratio in the range of 1:1 to 1:4, or more specifically from 1:1.1 to 1:4, without pleating of the composite.

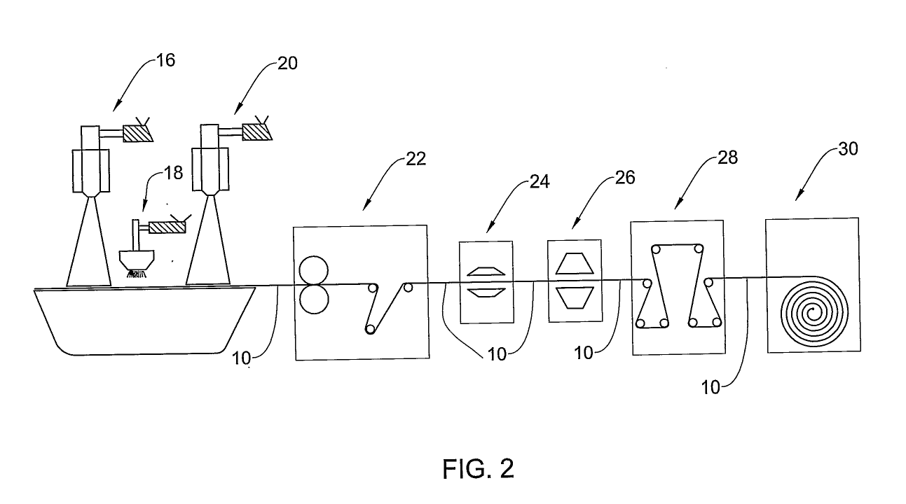

As illustrated in FIG. 2, during manufacture of the non-woven material illustrated in FIG. 1C (i.e., the SMS material), the at least one base (spunbond) layer 12 is formed by a conventional spunbond process, as indicated schematically at 16. For example, PO is forced through an extruder or extruders. Typically, the spinneret orifice diameters are within the range of up to 1 mm, although greater diameters may be used. The extruded material is then quenched, e.g., with air directed transverse to the extrusion direction. High velocity air may be subsequently directed parallel to the extrusion direction. The fibers are then randomly deposited onto a conveyor belt, which carries them in a movement direction (MD).

Subsequently, the first auxiliary layer (meltblown) 14 is formed by a conventional meltblown process, as indicated schematically at 18. The elastic material is extruded through spinneret with orifices diameter of 0.3-1.2 mm, and a hot air stream is used to draw the extruded polymer into fine fibers, thus forming the (meltblown) auxiliary layer 14 on the previously formed layer.

Subsequently, as indicated schematically at 20, other layers, the next auxiliary layer (spunbond) 14 is formed as described above with reference to the base layer 12. It will be appreciated that the setup illustrated in FIG. 2 is schematic, and the number and types of equipment to be used in practice depends on the specific permutation of layers to be used to form the material 10.

The above results in fibers which typically have diameters in the range between 8 and 25 microns in the base layer 12 (i.e., for spunbond PO), and diameters in the range between 3 and 35 microns in each of the elastic layers, whether they are spunbond or meltblown.

Once the layers are formed as described above, the layers may be heat-bonded together, as indicated schematically at 22, for example by being passed through one or more calender rollers. The calendar rollers may supply total calendaring, or partial calendaring, for example to impart a pattern to the material 10.

Subsequently, as indicated at 24, a web is formed by hydro-entanglement of the layers, such as by a conventional hydro-entanglement or steam (spunlace) process. In such a process, the layers are subjected to fine jets of water at high pressure or to steam jets. The water or steam jets, upon contacting the layers, entangle the fibers of the various layers, thereby interlocking the fibers of different layers together. The number of water jets and their arrangement, as well as the pressure and diameter of each one, may be altered to produce material having specific properties.

The layers are mechanically bonded, for example by hydro entanglement, e.g., with one or more jets. For example, the first jet may have a pressure of 150 bar, and,the sixth jet may have a pressure of 220 bar. Up to ten or more jets, each, having operating pressures of up to 500 bar, may be used. In addition, at least one or more vacuum cylinders or wire mesh vacuum belts may have patterning capabilities.

It will be appreciated that which the hydro-entanglement is described as occurring after the heat-bonding, it may precede it.

At this point, as indicated schematically at 26, one or more surfactants may optionally be applied to the material in order to impart desired qualities, such as hydrophobic or hydrophilic properties, anti-microbial properties, flame-retardancy, anti-static properties, etc., as is well known in the art. The surfactants may be applied over the entire area of the material, or each selectively applied in one or more predetermined regions, e.g., based on the intended use of the material. Alternatively or additionally, the PP used in the SB process may contain additives to impart desired qualities thereto. Subsequently, the material is passed through a dryer (not illustrated).

Before the material is rolled, it is subjected to stretching (i.e., it is pre-stretched) in either the movement direction (MD) or the cross direction (CD), or both, as indicated schematically at 28. The amounts of stretching in each direction may be different from one another, and determine the final elasticity, i.e., the stretching and recovery ratios, of the material in each direction. The stretching may be performed when the material is in either a heated state of an unheated state (i.e., in the absence of any additional heating), and in one or more stages. This stretching ratio may be from 0-400% in each direction, based on the intended use of the material. Using multiple steps of stretching and heating can affect the elastic properties of the composite by impacting the annealing and stress relief of the elastic layer, thus achieving different stretch and recovery properties. In addition, the multiple steps of stretching may also impart a specific look and hand feel of the composite.

Subsequent to stretching, the material is rolled, as indicated schematically at 30.

The resulting material is non-pleated and can be stretched when an axial force is applied in the plane thereof, and returns back to its initial state when the force is removed. Such a material may be useful in manufacturing clothing, hygiene products (e.g., diapers), medical products (e.g., bandages), etc.

It will be appreciated that while an example of manufacture of an SMS material has been described in connection with FIG. 2, the process may be altered to produce any desired material, including those comprising at least some of spunbond, carded thermo-bond, and meltblown layers.

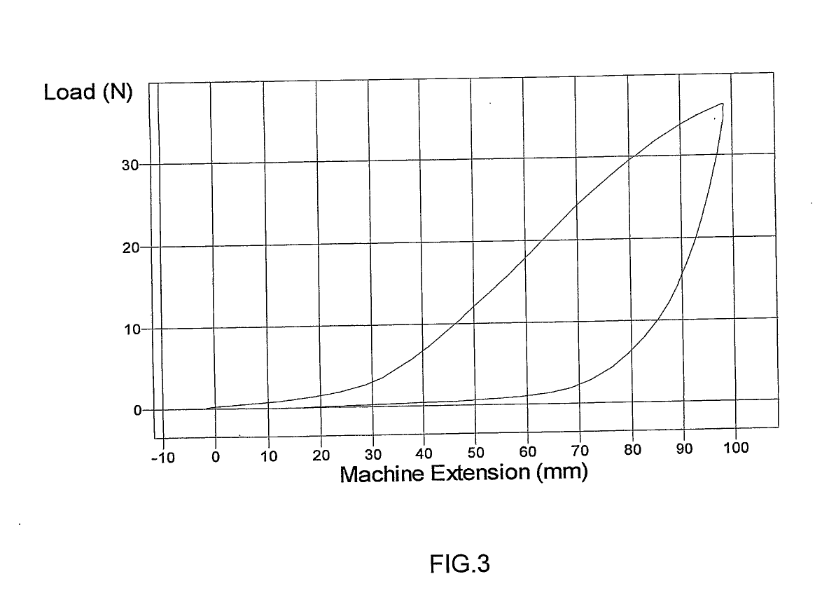

An SSS material may be formed, for example composed of fibers having a to basis weight of 13 g/m² for the spunbond base layer 12, 40 g/m² for the next layer, which is an elastic auxiliary layer 14, and 13 g/m² for the next layer, which is another auxiliary layer 14. The SSS material may be stretched at a 1:3 stretching ration in the CD direction, which results in a material having predetermined elastic properties. FIG. 3 illustrates a hysteresis curve of one example of such a material.

It will be appreciated that by providing non-woven material as described with a base layer made of a non-elastic material, a non-woven material which exhibits desired elastic properties, but which has at least one surface which does not have the sometimes objectionable texture associated with an elastic material, is provided. If it is desired that both surfaces of the non-woven do not have the texture associated with an elastic material, the final auxiliary layer may also be made from a non-elastic material.

It will be appreciated that by providing a non-woven material as described above, the non-elastic base layer may be micro-pleated. This leads to a thicker overall material, at least when un-stretched, which is generally associated with (i.e., perceived as) a softer material.

Those skilled in the art to which this invention pertains will readily appreciate that numerous changes, variations and modifications can be made without departing from the scope of the invention mutatis mutandis.

1. A non-woven material comprising an external non-elastic base layer and an auxiliary layer comprising an elastic material, the base layer and auxiliary layer being mechanically bonded together.

2. The non-woven material according to claim 1, wherein the mechanical bonding comprises any one or more of hydro-entanglement and needle punching.

3. (canceled)

4. The non-woven material according to claim 1, being pre-stretched.

5. The non-woven material according to claim 1, the base layer comprising a layer selected from the group consisting of a spunbond layer, a carded thermo-bond layer, and a meltblown layer.

6. The non-woven material according to claim 1, the auxiliary layer comprising one or more layers, each selected from the group consisting of a spunbond layer, a carded thermo-bond layer, and a meltblown layer.

7. The non-woven material according to claim 1, the auxiliary layer comprising one or more layers, at least one of the layers comprising a thermoplastic elastomer material.

8. The non-woven material according to claim 7, the thermoplastic elastomer material being selected from the group consisting of polypropylene, polyethylene, and polystyrene.

9. The non-woven material according to claim 1, the auxiliary layer comprising one or more layers, at least one of the layers comprising a material selected from the group consisting of thermoplastic elastomeric material, elastomeric block copolymer, amorphous polyolefin plastomer, and thermoplastic elastomeric copolymer.

10. The non-woven material according to claim 1, at least one of the layers being made of two different materials formed as a bi-component material.

11. The non-woven material according to claim 1, having a stretching ratio substantially in the range between 10-400% elongation.

12. The non-woven material according to claim 1, having a permanent set substantially equal to or below 20%.

13. The non-woven material according to claim 12, wherein the permanent set is substantially within the range of 8%-15%.

14. The non-woven material according to claim 1, the base layer being micro-pleated.

15. An article comprising a non-woven material according to claim 1.

16. (canceled)

17. (canceled)

18. (canceled)

19. A process for manufacturing a non-woven material, comprising:
providing a non-elastic base layer;
providing at least one auxiliary layer of an elastic material on one side of the base layer; and
mechanically bonding the base and auxiliary layers to form the non-woven material.

20. The process according to claim 19, further comprising stretching the material in two perpendicular directions.

21. The process according to claim 20, comprising multiple stretching of the material in at least one of the directions.

22. The process according to claim 20, wherein different stretchings are performed at different amounts.

23. The process according to claim 20, at least some of the stretchings being performed while the material is heated.

24. (canceled)

25. The process according to claim 19, wherein the mechanical bonding comprises any one or more of hydro-entanglement and needle punching.

26. (canceled)

27. The process according to claim 19, further comprising any one or more of steam entangling the layers and calendaring the material.

28. (canceled)

29. (canceled)
